(19) United States
(12) Patent Application Publication
(10) Pub. No.: US 2025/0104886 A1
(43) Pub. Date: Mar. 27, 2025

(54) COMPOSITE CABLE AND COMPOSITE HARNESS

(71) Applicant: Proterial, Ltd., Tokyo (JP)

(72) Inventors: Hirotaka ESHIMA, Tokyo (JP); Yoshikazu HAYAKAWA, Tokyo (JP); Takahiro FUTATSUMORI, Tokyo (JP)

(21) Appl. No.: 18/813,693

(22) Filed: Aug. 23, 2024

(30) Foreign Application Priority Data
Sep. 21, 2023 (JP) 2023-155563

(51) Int. Cl. H01B 9/00; H01B 7/00; H01B 7/18

(52) U.S. Cl. CPC H01B 9/003; H01B 7/0045; H01B 7/1895

(57) ABSTRACT

A composite cable includes a plurality of power lines for supplying operating power to a device to be controlled, a plurality of first signal lines for transmitting control signals for controlling the device to be controlled, a plurality of second signal lines for redundancy of the plurality of first signal lines; and a sheath collectively covering the plurality of power lines, the plurality of first signal lines, and the plurality of second signal lines, wherein a signal line section where the plurality of first signal lines and the plurality of second signal lines are twisted together and the plurality of power lines are stranded together inside the sheath, and wherein the plurality of first signal lines and the plurality of second signal lines are collectively twisted in a spiral shape around a central axis of the signal line section.

### CROSS-REFERENCE TO RELATED APPLICATIONS

The present patent application claims the priority of Japanese patent application No. 2023-155563 filed on Sep. 21, 2023, and the entire contents thereof are hereby incorporated by reference.

### TECHNICAL FIELD

This invention relates to a composite cable having a plurality of power lines and a plurality of signal lines, and to a composite harness with a connector disposed at the end of the composite cable.

### BACKGROUND OF THE INVENTION

Conventionally, for example, in electric brake systems for vehicles, duplication or redundancy of equipment has been considered to improve reliability. Patent Literature 1 discloses an electric brake device in which a motor that applies braking force to the wheel, a first motor drive unit that drives a first set of winding wires of the motor, and a second motor drive unit that drives a second set of winding wires of the motor are provided on the vehicle wheel-side, and a controller that controls the first motor drive unit and the second motor drive unit is provided on the vehicle body-side, wherein the first motor drive unit and the controller are connected by a first communication line, and the second motor drive unit and the controller are connected by a second communication line.

### CITATION LIST

### Patent Literature 1: JP2018-30463A

### SUMMARY OF THE INVENTION

In the electric brake device described in Patent Literature 1, the vehicle wheel-side and the vehicle body-side are connected by the first communication line, the second communication line, and an electric wire that supplies power from the vehicle body-side to the vehicle wheel-side. If these two communication lines and the electric wire are covered together with a sheath and configured as a single cable, the outer diameter of the cable becomes thicker. Here, it is desirable for a cable for the electric brake device to have a thin outer diameter and high flexibility, because a part of the cable in the longitudinal direction is repeatedly bent by the wheel movement against the vehicle body when the vehicle is running. In other words, if the two communication lines and the electric wire for supplying power are configured as a single cable in the electric brake device described in Patent Literature 1, the outer diameter of the cable becomes thicker due to the two communication lines, which may reduce the routability, and the repeated bending may cause the cable to break easily.

Therefore, it is an object of the present invention to provide a composite cable that enables a reduction in the cable outer diameter while including redundant wires for transmitting control signals to control a device to be controlled, and a composite harness equipped with the composite cable and the connector.

For solving the above problem, one aspect of the present invention provides a composite cable, comprising:
a plurality of power lines for supplying operating power to a device to be controlled;
a plurality of first signal lines for transmitting control signals for controlling the device to be controlled;
a plurality of second signal lines for redundancy of the plurality of first signal lines; and
a sheath collectively covering the plurality of power lines, the plurality of first signal lines, and the plurality of second signal lines,
wherein a signal line section where the plurality of first signal lines and the plurality of second signal lines are twisted together and the plurality of power lines are stranded together inside the sheath, and
wherein the plurality of first signal lines and the plurality of second signal lines are collectively twisted in a spiral shape around a central axis of the signal line section.

For solving the above problem, another aspect of the present invention provides a composite harness having the composite cable described above and the connector disposed at an end of the composite cable.

### ADVANTAGEOUS EFFECTS OF THE INVENTION

The present invention makes it possible to provide a composite cable that enables a reduction in the cable outer diameter while including redundant wires for transmitting control signals to control a device to be controlled, and a composite harness equipped with the composite cable and the connector.

### BRIEF DESCRIPTION OF DRAWINGS

FIG. 1 is a schematic diagram illustrating a configuration example of a vehicle having a composite cable and a composite harness according to the first embodiment.

FIG. 2 is an explanatory diagram illustrating a configuration example of an electric brake unit together with parts of a composite cable and a composite harness.

FIG. 3 is a cross-sectional view of the composite cable.

FIG. 4 is an explanatory diagram illustrating a configuration example of a vehicle wheel-side connector, a mating connector of an electric brake unit that is mated to the vehicle wheel-side connector, and a communication circuit section of a control unit.

FIG. 5 is a sectional view illustrating a configuration of a composite cable shown as a comparative example.

FIG. 6 is an explanatory diagram illustrating a configuration of a composite cable and a composite harness according to a second embodiment.

### DETAILED DESCRIPTION OF THE INVENTION

### First Embodiment

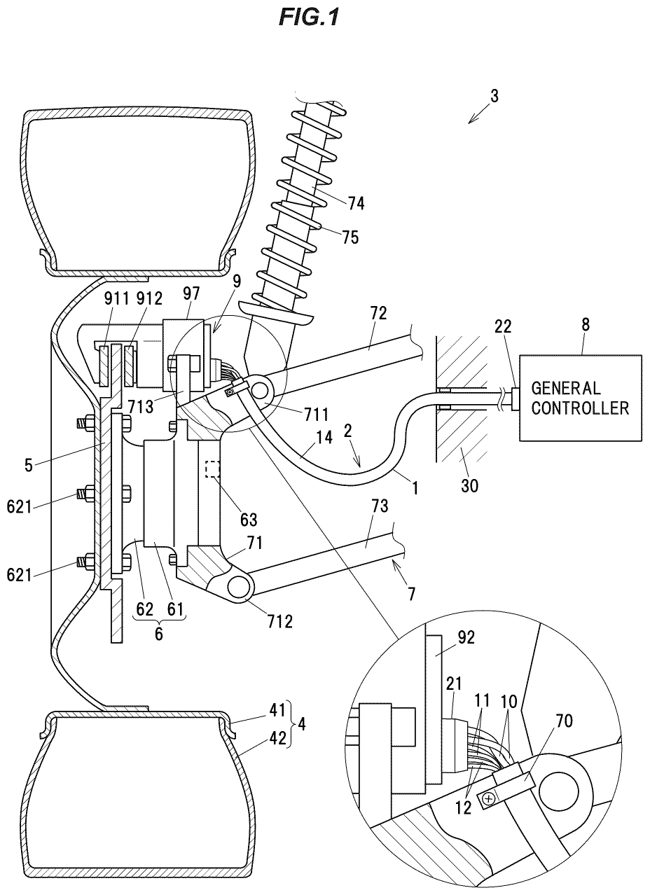

FIG. 1 is a schematic diagram illustrating a configuration example of a vehicle 3 having a composite cable 1 and a composite harness 2 according to the first embodiment. The vehicle 3 comprises a vehicle wheel 4 having a wheel 41 made of metal and a tire 42 made of rubber, a brake rotor 5 rotating together with the wheel 41, a hub unit 6 that rotatably supports the vehicle wheel 4 and the brake rotor 5, a suspension system 7 that supports the hub unit 6 against the vehicle body 30, a general controller 8 which is a control unit to comprehensively control the vehicle 3, and the electric brake unit 9, which brakes the vehicle wheel 4 under directions from the general controller 8.

The suspension system 7 includes a knuckle 71, an upper arm 72, a lower arm 73, a damper 74, and a suspension spring 75. The upper arm 72 and the lower arm 73 are respectively connected to the knuckle 71 at one end and to the vehicle body 30 at the other end. The hub unit 6 has an outer wheel 61 attached to the knuckle 71, a hub wheel 62 rotatably supported with respect to the outer wheel 61, and a wheel speed sensor 63 that detects the rotation speed of the vehicle wheel 4. The knuckle 71 has a first connecting section 711 to which the upper arm 72 and damper 74 are connected, a second connecting section 712 to which the lower arm 73 is connected, and a mounting section 713 to which the electric brake unit 9 is attached.

The wheel 41 and the brake rotor 5 are fixed to the hub wheel 62 of the hub unit 6 by a plurality of hub bolts 621. The wheel speed sensor 63 detects the rotation speed of the hub wheel 62 relative to the outer wheel 61 as the rotation speed of the vehicle wheel 4, and outputs a detection signal indicating the detection result to the general controller 8 by means of a sensor cable not shown in the drawing. The general controller 8 controls the electric brake unit 9 based on information such as the amount of depressing the brake pedal by the driver of the vehicle 3 and the rotation speed of the vehicle wheel 4 detected by the wheel speed sensor 63. The electric brake unit 9 is a target device of the general controller 8, which is to be controlled by the general controller 8.

The electric brake unit 9, together with the vehicle wheels 4, the brake rotor 5, the hub unit 6, and the knuckle 71, moves vertically with respect to the vehicle body 30 as the suspension spring 75 extends and retracts. A part in the longitudinal direction of the composite cable 1 is wired in the air and connects the electric brake unit 9 to the general controller 8.

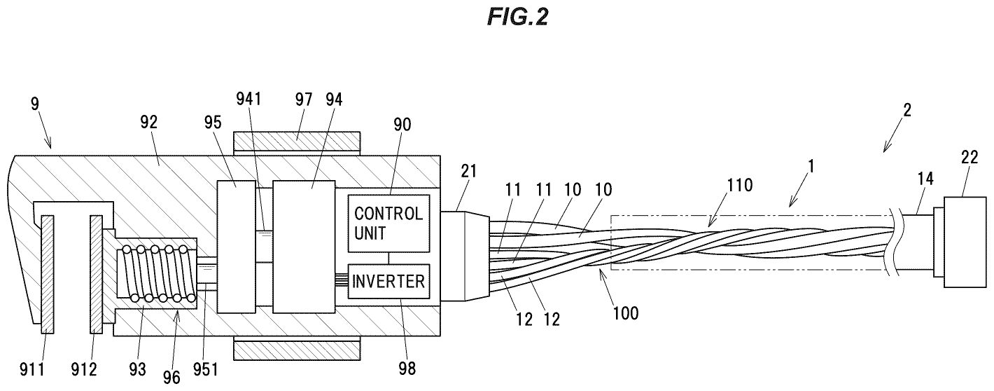

FIG. 2 is an explanatory diagram illustrating a configuration example of the electric brake unit 9 together with the composite cable 1 and the composite harness 2. The electric brake unit 9 is composed of a control unit 90 that communicates with the general controller 8 via the composite cable 1, an outer brake pad 911 and an inner brake pad 912, a caliper 92 with the outer brake pad 911 attached, and a piston 93 with the inner brake pad 912 attached, a motor 94 which is the driving source of the electric brake unit 9, a reduction gear 95 which reduces the rotation of a motor shaft 941, an output shaft of the motor 94, and a rotation-linear motion converting mechanism 96 which converts the rotary motion of an output shaft 951 of the reduction gear 95 into linear motion of the piston 93, a caliper bracket 97 which is fixed to the mounting section 713 of the knuckle 71, and an inverter 98 which supplies current to the motor 94. The caliper 92 is supported by the caliper bracket 97 and can move parallel to the axis of rotation of the vehicle wheel 4 with respect to the caliper bracket 97.

The reduction gear 95 reduces the rotation of the motor shaft 941 and transmits the torque of the motor 94 to the rotation-linear motion converting mechanism 96. The rotation-linear motion converting mechanism 96 is composed of a ball screw mechanism, for example. When the motor 94 rotates by the current supplied from the inverter 98, the outer brake pad 911 and the inner brake pad 912 are pressed toward the brake rotor 5 by the pressing force corresponding to the torque generated by the motor 94, and the vehicle wheel 4 is braked by the frictional force generated between the outer brake pad 911 and the inner brake pad 912 and the brake rotor 5.

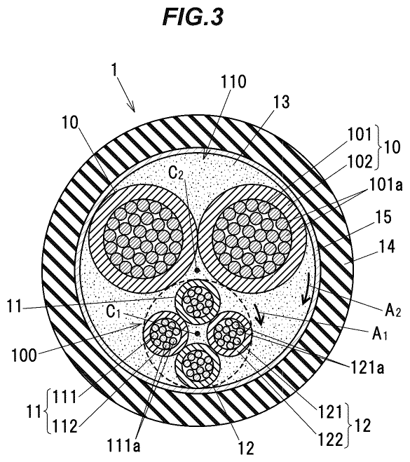

FIG. 3 is a cross-sectional view of the composite cable 1. The composite cable 1 has a plurality of power lines 10 for supplying operating power to the electric brake unit 9, a plurality of first signal lines 11 transmitting control signals for controlling the electric brake unit 9, a plurality of second signal lines 12 for redundancy of the plurality of first signal lines 11, a fiber-like filler 13, and a hollow tubular sheath 14. The number of power lines 10, first signal lines 11, and second signal lines 12 included in the composite cable 1 are two each.

The two power lines 10 is composed of one positive power line and one negative power line. These power lines 10 are insulated wires each of which includes a center conductor 101 covered with an insulator 102 made of insulating resin. The center conductor 101 is a stranded wire composed of a plurality of conductor strands 101a twisted together. The voltage supplied to the electric brake unit 9 by the two power lines 10 is, for example, DC 12 V. The control unit 90 of the electric brake unit 9 is equipped with an electric circuit that operates by means of a voltage transformed by a DC-DC converter from the voltage supplied to the electric brake unit 9 by the two power lines 10, and the inverter 98 switches the voltage supplied to the electric brake unit 9 by the two power lines 10, and outputs it to the motor 94.

The two first signal lines 11 are insulated wires each of which includes a center conductor 111 covered with an insulator 112 made of insulating resin. The center conductor 111 is a stranded wire consisting of a plurality of conductor strands 111a twisted together. Similarly, the two second signal lines 12 are insulated wires each consisting of a center conductor 121 covered with an insulator 122 made of insulating resin. The center conductor 121 is a stranded wire consisting of a plurality of conductor strands 121a twisted together. The first signal line 11 and the second signal line 12 have the common specifications such as outer diameter and material.

The filler 13 is a fibrous material such as, for example, aramid or nylon fibers. The sheath 14 is made of a resin such as soft polyurethane with excellent flexibility and durability. The sheath 14 collectively covers the plurality of power lines 10, the plurality of first signal lines 11, the plurality of second signal lines 12, and the filler 13. In the vicinity of the electric brake unit 9, the sheath 14 is removed and the plurality of power lines 10, the plurality of first signal lines 11, and the plurality of second signal lines 12 are exposed from the sheath 14. In FIG. 2, the plurality of power lines 10, plurality of first signal lines 11, and plurality of second signal lines 12 inside the sheath 14 are illustrated, with a portion of the sheath 14 shown as two dotted lines.

The general controller 8 outputs command signals indicating the magnitude of the braking force to be generated by the electric brake unit 9 to the two first signal lines 11 and the two second signal lines 12. The signals output to the two first signal lines 11 and the signals output to the two second signal lines 12 are identical. The control unit 90 outputs PWM signals to the inverter 98 to control the motor 94 so that a braking force is generated in accordance with these command signals.

The plurality of first signal lines 11 and the plurality of second signal lines 12 are twisted together to form a signal line section 100. The signal line section 100 and the plurality of power lines 10 are twisted together inside the sheath 14 to form a wire assembly 110. The plurality of first signal lines 11 and the plurality of second signal lines 12 are collectively twisted together in a spiral shape around the central axis C1 of the signal line section 100 shown in FIG. 3. The signal line section 100 and the plurality of power lines 10 are twisted together in a spiral shape around the central axis C2 of the composite cable 1. A tape member 15 made of resin such as PET (Polyethylene Terephthalate), for example, is wound around the periphery of the wire assembly 110. A shield layer made of a shield conductor such as a braided shield may be provided around the periphery of the signal line section 100.

In FIG. 3, the direction of twisting of the plurality of first signal lines 11 and plurality of second signal lines 12 and the direction of twisting of the signal line section 100 and plurality of power lines 10 are indicated by arrows A1 and A2 respectively. In the present embodiment, the direction of twisting of the plurality of first signal lines 11 and the plurality of second signal lines 12 and the direction of twisting of the signal line section 100 and the plurality of power lines 10 are the same. This allows the twists of the signal line section 100 and the wire assembly 110 to tighten and loosen together when the composite cable 1 is twisted, and as a result, distributes the load and improves durability against twisting. However, not limited to this, the direction of twisting of the plurality of first signal lines 11 and plurality of second signal lines 12 and the direction of twisting of the signal line section 100 and the plurality of power lines 10 may be reversed. In this case, bending habits of the composite cable 1 caused by twisting can be suppressed.

In the present embodiment, the plurality of (two) first signal lines 11 are arranged adjacent to each other in the circumferential direction centered on the central axis C1 and the plurality of (two) second signal lines 12 are arranged adjacent to each other in the circumferential direction centered on the central axis C1. This makes it easier to separate the first signal lines 11 from the second signal lines 12 in the terminal treatment operation of the composite cable 1, thereby improving workability. The two first signal lines 11 and the two second signal lines 12 have different colors of insulators 112 and 122 respectively, and the terminal treatment is performed based on these colors.

As shown in FIG. 1, the end of the sheath 14 on the vehicle wheel 4-side is fixed to the first connecting section 711 of the knuckle 71 by the fixture 70 in the vicinity of the electric brake unit 9. By fixing the end of the sheath 14 near the electric brake unit 9, the length of the plurality of power lines 10, the plurality of first signal lines 11, and the plurality of second signal lines 12 in the portion exposed from the sheath 14 are shortened, and the length of the plurality of power lines 10, the plurality of first signal lines 11, and the plurality of second signal lines 12 protected by the sheath 14 are lengthened. Additionally, the plurality of power lines 10, first signal lines 11, and second signal lines 12 exposed from the sheath 14 may be covered by a tubular protective material.

The composite harness 2 has a composite cable 1, a vehicle wheel-side connector 21 disposed at one end of the composite cable 1, and a vehicle body-side connector 22 disposed at the other end of the composite cable 1. The vehicle wheel-side connector 21 is attached to the electric brake unit 9. The vehicle body-side connector 22 is attached to the general controller 8. The plurality of power lines 10, the plurality of first signal lines 11, and the plurality of second signal lines 12 have one end connected to the terminals of the vehicle wheel-side connector 21 and the other end connected to the terminals of the vehicle body-side connector 22.

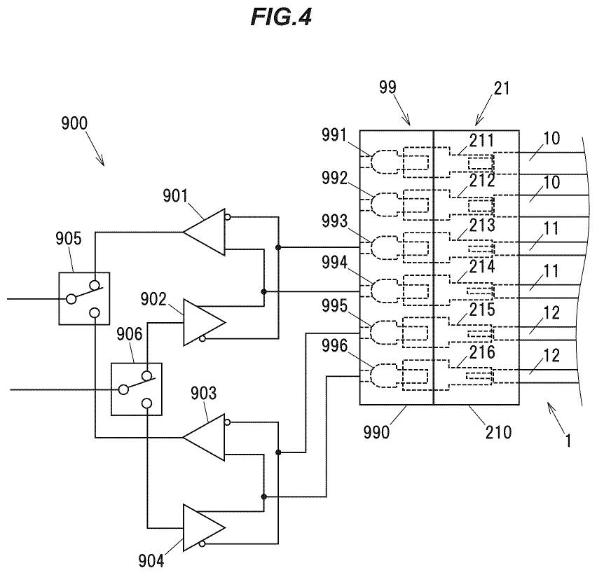

FIG. 4 is an explanatory diagram illustrating a configuration example of the vehicle wheel-side connector 21, a mating connector 99 of the electric brake unit 9 that is mated to the vehicle wheel-side connector 21, and a communication circuit unit 900 of the control unit 90. The vehicle wheel-side connector 21 has a connector housing 210 made of insulating resin and first to sixth terminals 211 to 216. The plurality of power lines 10, the plurality of first signal lines 11, and the plurality of second signal lines 12 are respectively connected to the first to sixth terminals 211 to 216.

The mating connector 99 has a connector housing 990 made of insulating resin, and first to sixth terminals 991 to 996 that are respectively connected to the first to sixth terminals 211 to 216 of the vehicle wheel-side connector 21. The first and second terminals 991, 992 of the mating connector 99, which are electrically connected to the first and second terminals 211, 212 of the vehicle wheel-side connector 21 to which the plurality of power lines 10 are connected, are respectively connected to a power pattern and a ground pattern of the substrate of the control unit 90.

In the example shown in FIG. 4, the two first signal lines 11 are used as a permanent system and the two second signal lines 12 are used as a reserve system. The communication circuit unit 900 comprises a first transceiver 901 and a first receiver 902 electrically connected to each of the two first signal lines 11, a second transceiver 903 and a second receiver 904 electrically connected to each of the two second signal lines 12, and first and second switching circuits 905, 906. The CPU (central processing unit) of the control unit 90 communicates with the general controller 8 using the first transceiver 901 and the first receiver 902 in normal operation, and when the communication with the general controller 8 is not normal, the first and second switching circuits 905, 906 are switched to communicate with the general controller 8 using the second transceiver 903 and the second receiver 904.

### COMPARATIVE EXAMPLE

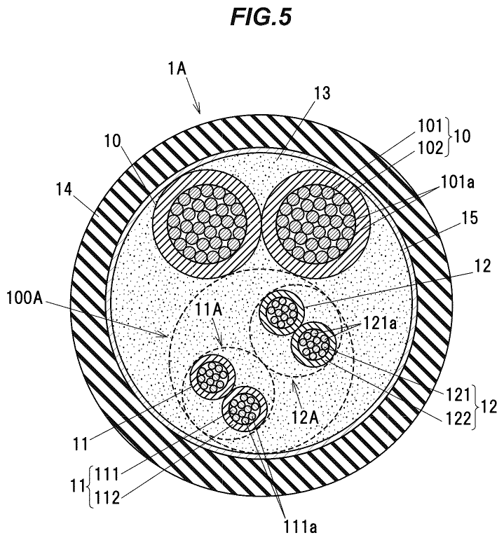

FIG. 5 is a cross-sectional view illustrating a configuration of a composite cable 1A shown as a comparative example. As the composite cable 1 according to the first embodiment, the composite cable 1A according to the comparative example has two power lines 10, two first signal lines 11, and two second signal lines 12, but the configuration of the twisting of the plurality of first signal lines 11 and second signal lines 12 is different. In the composite cable 1A according to the comparative example, a signal line section 100A is composed of a first twisted pair wire 11A consisting of the two first signal lines 11 twisted together and a second twisted pair wire 12A consisting of the two second signal lines 12 twisted together.

In the composite cable 1A according to the comparative example, the maximum outer diameter of signal line section 100A is the combined dimensions of the outer diameters of the two first signal lines 11 and the two second signal lines 12, which is larger than the outer diameter of the signal line section 100 of the composite cable 1 according to the first embodiment. This also makes the outer diameter of the composite cable 1A larger than that of the composite cable 1 according to the first embodiment.

### Effects of the First Embodiment

According to the first embodiment described above, even if any of the plurality of first signal lines 11 is broken or otherwise damaged, the plurality of second signal lines 12 can be used to communicate with the general controller 8, thereby improving reliability. In addition, the configuration in which the plurality of first signal lines 11 and the plurality of second signal lines 12 are twisted together in a spiral shape collectively allows the outer diameter of the signal line section 100 and the composite cable 1 to be reduced, which enhances the routability of the composite cable 1 and provides high bending endurance and disconnection resistance.

### Second Embodiment

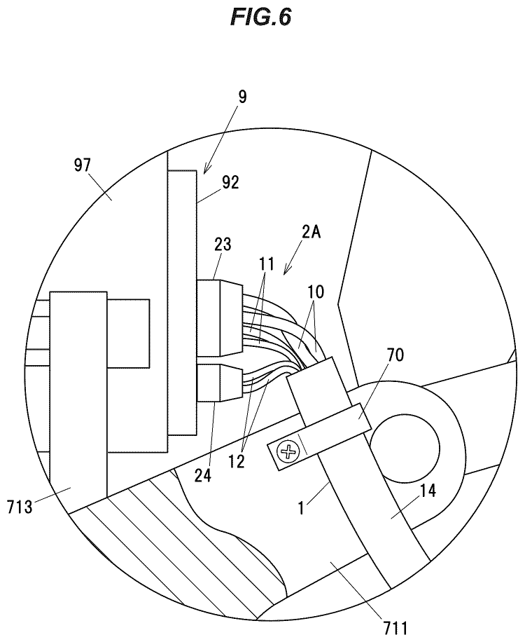

Next, the second embodiment is described with reference to FIG. 6. FIG. 6 is an explanatory diagram illustrating a configuration of a composite harness 2A according to the second embodiment. While the first embodiment described a case in which one vehicle wheel-side connector 21 is provided at one end of the composite cable 1, the composite harness 2A according to the second embodiment has a first vehicle wheel-side connector 23 and a second vehicle wheel-side connector 24 that are attached to the electric brake unit 9 at one end of the composite cable 1. The first vehicle wheel-side connector 23 is disposed at the end of the plurality of power lines 10 and the plurality of first signal lines 11, and the second vehicle wheel-side connector 24 is disposed at the end of the plurality of second signal lines 12.

The first vehicle wheel-side connector 23 and the second vehicle wheel-side connector 24 are vertically aligned. In the example shown in FIG. 6, the second vehicle wheel-side connector 24 is attached to the electric brake unit 9 vertically below the first vehicle wheel-side connector 23. As a result, the second vehicle wheel-side connector 24 prevents stepping stones generated by the tire 42 bouncing up stones on the road surface from hitting the first vehicle wheel-side connector 23. In other words, the first vehicle wheel-side connector 23 is protected by the second vehicle wheel-side connector 24.

### Summary of the Embodiments

Next, technical ideas understood from the first and second embodiments explained above will be described with reference to the reference numerals and the like used in the embodiments. However, each reference numeral in the following description does not limit the constituent elements in the scope of claims to the members and the like specifically shown in the embodiments.

[1] A composite cable (1) includes a plurality of power lines (10) for supplying an operating power to a device to be controlled (electric brake unit 9); a plurality of first signal lines (11) for transmitting control signals for controlling the device to be controlled (9); a plurality of second signal lines (12) for redundancy of the plurality of first signal lines (11); and a sheath (14) collectively covering the plurality of power lines (10), the plurality of first signal lines (11) and the plurality of second signal lines (12), wherein a signal line section (100) in which the plurality of first signal lines (11) and the plurality of second signal lines (12) are twisted together is stranded with the plurality of power lines (10) inside the sheath (14), and wherein the plurality of first signal lines (11) and the plurality of second signal lines (12) are collectively twisted in a spiral shape around the central axis (C1) of the signal line section (100).

[2] In the composite cable (1) according to [1], the plurality of first signal lines (11) are arranged adjacent to each other in a circumferential direction around the central axis (C1) and the plurality of second signal lines (12) are arranged adjacent to each other in a circumferential direction around the central axis (C1).

[3] In the composite cable (1) according to [1], the device to be controlled (9) is an electric brake unit (9) that brakes a vehicle wheel (4).

[4] A composite harness (2, 2A) includes a composite cable (1) according to any of [1] to [3]; and a connector (21, 22, 23, 24) is disposed at the end of the composite cable (1).

[5] In the composite harness (2A) according to [4], wherein the signal line section (100) is split outside the sheath (14) into the plurality of first signal lines (11) and the plurality of second signal lines (12), wherein a first connector (23) is provided at the terminals of the plurality of power lines (10) and the plurality of first signal lines (11), and wherein a second connector (24) is provided at the terminals of the plurality of second signal lines (12).

The first and second embodiments of the invention have been described above, but these embodiments do not limit the invention according to the scope of claims. Additionally, it should be noted that not all of the combinations of features described in the embodiments are essential to the means for solving problems of the invention.

1. A composite cable, comprising:
a plurality of power lines for supplying operating power to a device to be controlled;
a plurality of first signal lines for transmitting control signals for controlling the device to be controlled;
a plurality of second signal lines for redundancy of the plurality of first signal lines; and
a sheath collectively covering the plurality of power lines, the plurality of first signal lines, and the plurality of second signal lines,
wherein a signal line section where the plurality of first signal lines and the plurality of second signal lines are twisted together and the plurality of power lines are stranded together inside the sheath, and
wherein the plurality of first signal lines and the plurality of second signal lines are collectively twisted in a spiral shape around a central axis of the signal line section.

2. The composite cable according to claim 1, wherein the plurality of first signal lines are arranged adjacent to each other in a circumferential direction around the central axis, and the plurality of second signal lines is arranged adjacent to each other in the circumferential direction around the central axis.

3. The composite cable according to claim 1, wherein the device to be controlled is an electric brake unit that brakes a vehicle wheel.

4. A composite harness, comprising:
the composite cable according to claim 1; and
a connector provided at an end of the composite cable.

5. The composite harness according to claim 4, wherein the signal line section is split outside the sheath into the plurality of first signal lines and the plurality of second signal lines,
wherein a first connector is provided at terminals of the plurality of power lines and the plurality of first signal lines, and
wherein a second connector is provided at terminals of the plurality of second signal lines.
